(19) United States
(12) Patent Application Publication
(10) Pub. No.: US 2026/0339137 A1
(43) Pub. Date: Oct. 29, 2026

(54) INTEGRATION OF A RADIOFREQUENCY DEVICE AND OF A SMART TINTED GLASS DEVICE

(71) Applicant: Continental Automotive Technologies GmbH, Hannover, DE (US)

(72) Inventors: Stéphane BILLY, Grenade (FR); Sylvain GODET, Villeneuve-lès-Bouloc (FR); Jérôme LEE, Toulouse (FR)

(73) Assignee: Continental Automotive Technologies GmbH, Hannover (DE)

(21) Appl. No.: 19/367,603

(22) Filed: Oct. 23, 2025

(30) Foreign Application Priority Data
Oct. 29, 2024 (FR) FR2411803

(51) Int. Cl. G02F 1/133; H01Q 1/22

(52) U.S. Cl. CPC G02F 1/13312; H01Q 1/22

(57) ABSTRACT

A smart tinted glass device that can be selectively controlled between a transparent position and at least one opaque position. The device operates in a transparent mode in which it is continuously controlled in the transparent position and in an opaque mode in which it is alternately controlled in the opaque position and in the transparent position. The disclosure also relates to a radiofrequency device capable of cooperating with such a smart tinted glass device and configured to only transmit when the tinted glass device is in the transparent position.

### CROSS-REFERENCE TO RELATED APPLICATIONS

This application claims priority to FR 2411803, filed Oct. 29, 2024, the contents of such application being incorporated by reference herein.

### FIELD OF THE INVENTION

The invention relates to a radiofrequency device and its integration with a smart tinted glass device.

### BACKGROUND OF THE INVENTION

A smart tinted glass device is known.

Such a tinted glass device advantageously can be selectively controlled between at least one transparent position and at least one opaque position, typically by being electrically controlled. To this end, such a device comprises two parallel glass panes together enclosing a layer containing a material that can be selectively transparent or opaque. According to one embodiment, this material is a polymer, PCL, containing liquid crystals.

When no electrical voltage is applied to said material, the liquid crystals are homogeneously oriented in all directions, creating opacity. When an electrical voltage is applied, the liquid crystals tend to orient themselves in the same direction, allowing light to pass through and creating transparency. The strength of the voltage allows the degree of organization/disorganization of the liquid crystals to be varied, thereby obtaining variable opacity.

Selective control advantageously allows the opacity of a glass pane to be dynamically modified as a function of the electrical control that is applied.

Such a smart tinted glass device is generally used in a transparent mode, where it is continuously in the transparent position when visibility is required, for example, when driving a vehicle, and in an opaque mode, where it is continuously in the opaque position, when privacy or sun protection is required.

One problem with the opacity of the tinted glass device is that, if it prevents light from passing through, it also prevents radiofrequency waves from passing through. The opacity causes attenuation of up to 15 to 30 dB.

Thus, a means for overcoming this disadvantage is sought.

### SUMMARY OF THE INVENTION

To this end, an aspect of the invention proposes modifying the opaque mode of the tinted glass device from continuous control in the opaque position to control alternating between the opaque position and the transparent position.

The aim of an aspect of the invention is a smart tinted glass device that can be selectively controlled between a transparent position and at least one opaque position, wherein the device operates in a transparent mode in which it is continuously controlled in the transparent position and in an opaque mode in which it is alternately controlled in the opaque position and in the transparent position.

Specific features or embodiments, which can be used alone or in combination, are:
in the opaque mode, the opaque position is controlled at a frequency that is at least equal to 12 Hz, preferably at least equal to 15 Hz, even more preferably at least equal to 18 Hz;
the tinted glass device is connected to a radiofrequency device, wherein, in the opaque mode, the duration of a transparent position is at least equal to the transmission time of a frame of the radiofrequency device.

According to a second aspect, the invention relates to a radiofrequency device capable of cooperating with such a tinted glass device, configured to transmit when the tinted glass device is in the transparent position.

Specific features or embodiments, which can be used alone or in combination, are:
the radiofrequency device comprises an observer for observing the position of the tinted glass device, from among said at least one opaque position and the transparent position, in order to know when to transmit;
the radiofrequency device also comprises a synchronization means capable of requesting or controlling the transition of the tinted glass device to the transparent position before transmitting.

### BRIEF DESCRIPTION OF THE DRAWINGS

An aspect of the invention will be better understood from reading the following description, which is provided solely by way of an example, and with reference to the accompanying figures, in which:

FIG. 1 shows a smart tinted glass device as a section view;

FIG. 2 shows a block diagram of the method for synchronizing between the radiofrequency device and the tinted glass device.

### DESCRIPTION OF THE EMBODIMENTS

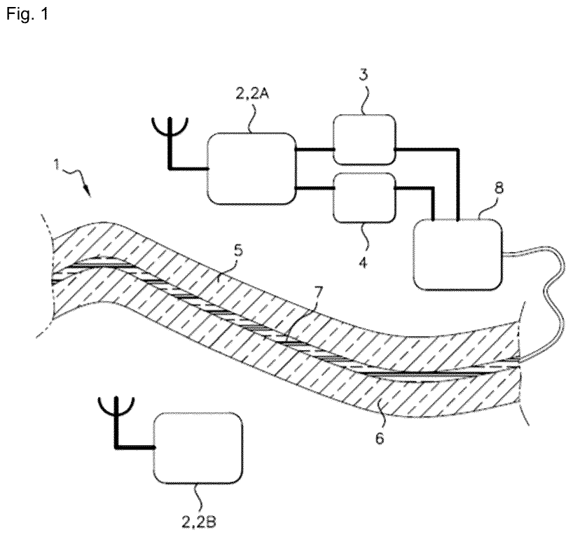

With reference to FIG. 1, an aspect of the invention relates to a tinted glass device 1. This tinted glass device 1 is referred to as a smart device in that it can be selectively controlled between a transparent position and at least one opaque position.

To this end, according to an illustrative embodiment, the tinted glass comprises two parallel glass or plastic panes 5, 6 enclosing an intermediate layer 7. This intermediate layer 7 comprises a polymer, in which liquid crystals are arranged. A control unit 8 completes the device 1 so as to allow a voltage to be applied to the liquid crystals of the intermediate layer 7 in order to change the state of the intermediate layer 7, and therefore of the tinted glass, between a transparent position and at least one opaque position, depending on the applied voltage.

Depending on the strength of the applied voltage, a whole range of opacity can be obtained. Furthermore, the tinted glass has a transparent position (or as transparent as possible) and one or more opaque positions.

Hereafter, reference is sometimes made to an opaque position. This can be any of the opaque positions, optionally a position that varies over time between various opaque positions.

According to the prior art, a smart tinted glass device is used in a transparent mode and in at least one opaque mode. In the transparent mode, the device 1 is continuously in the transparent position. In the at least one opaque mode, the device 1 is continuously in the opaque position, more specifically in an opaque position.

The device 1 according to an aspect of the invention operates in a transparent mode and in at least one opaque mode. The transparent mode is substantially identical to the transparent mode of the prior art: the device 1 is continuously controlled in the transparent position. According to one feature, each opaque mode differs from the opaque mode of the prior art in that the device 1 is alternately controlled in the opaque position (in an opaque position) and in the transparent position.

An aspect of the invention in this case benefits from persistence of vision. Persistence of vision stipulates that the human eye does not perceive a visual variation provided that its duration is less than a threshold that is substantially equal to 1/15^{th} of a second. This threshold can depend on the authors.

Thus, an interruption of an opaque position for the transparent position is not detected by the human eye, provided that said interruption is not too long.

Furthermore, according to another feature, in the opaque mode, the opaque position is controlled at a high enough frequency F. It follows that the transparent position is not detected by the human eye.

To this end, the frequency F is at least equal to 12 Hz, preferably at least equal to 15 Hz, even more preferably at least equal to 18 Hz. It should be noted that the frequency of 15 or 18 Hz guarantees compliance with the physiological threshold of 1/15^{th} of a second. By contrast, a frequency of 12 Hz theoretically is slightly low. It is assumed in this case that if detection is possible, it nevertheless is not sensitive enough to be troublesome for a user.

An aspect of the invention is advantageously used in conjunction with a radiofrequency device 2. As illustrated in FIG. 1, such a radiofrequency device 2 comprises a first transmitter, or, respectively, a first receiver device 2a, or both a transmitter and a receiver device, and a second receiver, or, respectively, transmitter device 2b, or both a receiver and a transmitter device, tuned to the first device 2a. The two devices 2a and 2b are arranged on either side of the tinted glass.

Furthermore, the tinted glass device 1 presents an obstacle to the propagation of radiofrequency waves. In addition, when the tinted glass device 1 is in the opaque position, this particular position adds additional attenuation of up to an additional 15 to 30 dB.

In the transparent mode, the tinted glass has standard attenuation corresponding to the prior art. Furthermore, transmission is possible without modifying the radiofrequency device relative to the prior art. By contrast, in the opaque mode, a permanent opaque position as in the prior art would be detrimental to transmission. Furthermore, the presence of transparent positions in the opaque mode according to an aspect of the invention is advantageously exploited to carry out transmissions during these transparent positions.

In order for a transmission to be entirely carried out in the transparent position, so as to avoid any risk of attenuation, according to another feature, the duration of the transparent position must be at least equal to the duration of an elementary transmission, i.e., the transmission time Trf of a frame of the radiofrequency device 2.

According to another aspect, the invention relates to a radiofrequency device 2 capable of cooperating with a tinted glass device 1 as described above. This radiofrequency device 2 is, according to one feature, configured to transmit when the tinted glass device 1 is in the transparent position.

As described above, the tinted glass device 1 is either in the transparent mode, where it is continuously in the transparent position, or in the opaque mode, where it alternates between the transparent position and the opaque position. The transparent mode is more convenient in that the transparent position is maintained for longer, which facilitates the transmissions. The opaque mode offers transparent position windows, yet these are shorter.

In both the transparent and opaque modes, it is important that the radiofrequency device 2 is in tune with the tinted glass device 1 in order to determine whether it is in the transparent position so that it can transmit. If necessary, if it is in the opaque position, the radiofrequency device 2 can wait for a transition to the transparent position or cause this transition.

To this end, according to another feature, the radiofrequency device 2 comprises an observer 3 for observing the position of the tinted glass device 1. This observer is capable of determining a position of the tinted glass device 1 from among the opaque position and the transparent position. This is so that the radiofrequency device 2 can determine when to transmit.

According to a first embodiment, the radiofrequency device 2 can, when it observes an opaque position, simply wait for the transition to the transparent position. If the tinted glass device 1 is configured to regularly alternate to the transparent position in the opaque mode, this can be enough to ensure an acceptable transmission delay.

However, if the tinted glass device 1 does not transition to the transparent position, or does not do so quickly enough depending on the time constraints of the radiofrequency device 2, another embodiment can involve the radiofrequency device 2 causing the tinted glass device 1 to transition to the transparent position.

Furthermore, according to another feature, the radiofrequency device 2 advantageously comprises a synchronization means 4. It is capable of requesting or controlling the transition of the tinted glass device 1 to the transparent position. To this end, the synchronization means 4 is typically interfaced with the radiofrequency device 2 and with the tinted glass device 1, typically via its processing unit 8. Thus, the radiofrequency device 2 advantageously uses the synchronization means 4 to switch the tinted glass device 1 to the transparent position before a transmission.

A request or a command is indicated. Two synchronization modes can be distinguished. A synchronization mode where the tinted glass device 1 is the master relative to the radiofrequency device 2 and a synchronization mode where the tinted glass device 1 is the slave relative to the radiofrequency device 2.

In the first mode, the radiofrequency device 2 requests a transition to the transparent position. The tinted glass device 1 remains the master and decides whether and when to execute, depending on its own constraints. The observer 3 then remains useful to the radiofrequency device 2 in order to determine when the transition to the transparent position is effective.

In the second mode, the radiofrequency device 2 commands a transition to the transparent position. The tinted glass device 1 is not the master and executes immediately. The observer 3 still can be useful, but secondarily, in order to check that the transition to the transparent position is effective.

Given the stricter time constraints of the radiofrequency device 2, the second mode, where the radiofrequency device 2 is the master, is preferred.

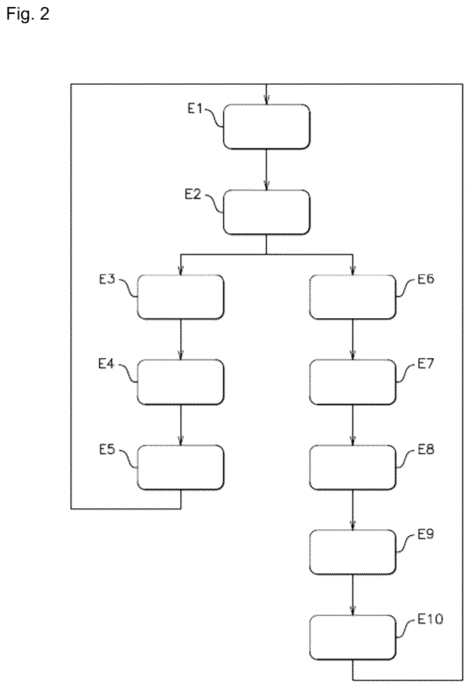

With reference to FIG. 2, the synchronization between the tinted glass device 1 and the radiofrequency device 2 will now be described.

Arbitrarily, everything starts in step E1 when the radiofrequency device 2 wishes to complete a transmission. This is expressed by a transmission request from the radiofrequency device 2.

During a second step E2, the radiofrequency device 2 polls the status of the tinted glass device 1. This is carried out by the radiofrequency device 2 using the observer 3. The observer feeds back the position of the tinted glass device, from among the transparent position and the opaque position.

If the feedback is the “transparent position”, the method continues to step E3: transparent position. Since the tinted glass device 1 is in the transparent position, the radiofrequency device 2 can transmit immediately.

This is carried out in step E4: frame transmission. During this step, the radiofrequency device 2 can transmit at least one frame, advantageously several frames, if the transparent position is maintained.

Advantageously, as indicated in step E5, the transparent position is maintained by a request or a command from the radiofrequency device 2. This can be active or passive. Either the radiofrequency device 2 controls the tinted glass device 1 and actively maintains the transparent position. Or the radiofrequency device 2 is subject to the tinted glass device 1. In this case, the radiofrequency device 2 knows the alternating pattern of the tinted glass device 1. It detects a transition to the transparent position by means of the observer 3 and it knows the minimum duration. Thus, in the opaque mode, it knows the duration and the recurrence of the transparent position and it can thus know how many frames it can transmit before a possible transition to the opaque position. If the transparent mode is detected, by observing an absence of an opaque position for a duration that is greater than a threshold, it is possible to transmit with virtually no restrictions before a transition to the opaque mode, which is always possible at any time.

After the transmission of one or more frames, the sequence returns to the initial step E1.

If, in step E2, the feedback is the “opaque position”, the method continues to step E6: opaque position. Since the tinted glass device 1 is in the opaque position, the radiofrequency device 2 cannot transmit immediately, but must cause or wait for a transparent position to occur.

This is expressed in step E7: request for transparency. This can correspond, depending on the relationship between the tinted glass device 1 and the radiofrequency device 2, to a command, a request or even to a delay, with the transition to the transparent position being periodic.

When the tinted glass device 1 transitions to the transparent position, the radiofrequency device 2 transitions to transmission. This is carried out in step E8: frame transmission. This step is identical to step E4 in every respect. During this step, the radiofrequency device 2 can transmit at least one frame, advantageously several frames, if the transparent position is maintained. As in step E4, the number of transmitted frames depends on the context.

If the tinted glass device 1 is in the transparent mode, there are no or few constraints, only a possible transition to the opaque mode. If the tinted glass device 1 is in the opaque mode, the transparent position should not be maintained for too long.

To this end, step E9 sets a timer that is set to the period 1/F, where F is the minimum alternating frequency of the opaque position. This timer can be managed by the tinted glass device 1, in the case of a master tinted glass device 1. Alternatively, this timer can be managed by the radiofrequency device 2, in the case of a master radiofrequency device 2.

No later than when this timer expires, any transmission is stopped and the tinted glass device 1 transitions to the opaque position, in step E10, by means of an opacity request or command.

The sequence then continues by returning to the initial step E1.

The invention has been illustrated and described in detail in the drawings and the preceding description. This should be considered to be illustrative and is provided by way of an example and not as limiting the invention to this description alone. Many alternative embodiments are possible.

### LIST OF REFERENCE SIGNS

1: smart tinted glass device;
2: radiofrequency device;
3: observer;
4: synchronization means;
5, 6: glass pane;
7: intermediate layer;
8: control unit;
F: position change frequency of the tinted glass device;
Trf: transmission time of a frame

1. A smart tinted glass device that can be selectively controlled between a transparent position and at least one opaque position, operating in a transparent mode in which it is continuously controlled in the transparent position and in an opaque mode in which it is alternately controlled in the opaque position and in the transparent position, wherein the smart tinted glass device is connected to a radiofrequency device wherein, in the opaque mode, the duration of a transparent position is at least equal to the transmission time of a frame of the radiofrequency device

2. The device as claimed in claim 1, wherein, in the opaque mode, the opaque position is controlled at a frequency that is at least equal to 12 Hz, preferably at least equal to 15 Hz, even more preferably at least equal to 18 Hz.

3. A radiofrequency device capable of cooperating with a smart tinted glass device that can be selectively controlled between a transparent position and at least one opaque position, operating in a transparent mode in which it is continuously controlled in the transparent position and in an opaque mode in which it is alternately controlled in the opaque position and in the transparent position, wherein the radiofrequency device is configured to only transmit when the tinted glass device is in the transparent position.

4. The radiofrequency device as claimed in claim 3, comprising an observer for observing the position of the tinted glass device from among said at least one opaque position and the transparent position, in order to only transmit when the tinted glass device is in the transparent position.

5. The radiofrequency device as claimed in claim 3, further comprising a synchronization device capable of requesting or controlling the transition of the tinted glass device to the transparent position, in order to only transmit when the tinted glass device is in the transparent position.

6. The radiofrequency device as claimed in claim 4, further comprising a synchronization device capable of requesting or controlling the transition of the tinted glass device to the transparent position, in order to only transmit when the tinted glass device is in the transparent position.
